(19) United States
(12) Patent Application Publication
(10) Pub. No.: US 2012/0274141 A1
(43) Pub. Date: Nov. 1, 2012

(54) VARIABLE CAPACITANCE DEVICE

(75) Inventor: Teruhisa SHIBAHARA, Nagaokakyo-shi (JP)

(73) Assignee: MURATA MANUFACTURING CO., LTD., Nagaokakyo-shi (JP)

(21) Appl. No.: 13/547,252

(22) Filed: Jul. 12, 2012

Related U.S. Application Data
(63) Continuation of application No. PCT/JP2010/073119, filed on Dec. 22, 2010.

(30) Foreign Application Priority Data
Jan. 28, 2010 (JP) 2010-016183

(51) Int. Cl. H01G 5/04; H01G 5/40

(52) U.S. Cl. 307/75; 307/109

(57) ABSTRACT

A variable capacitance device includes a substrate, a beam, a driving capacitance, a variable capacitance, and a driving voltage control circuit. The beam is connected to the substrate by a cantilever structure. The driving capacitance is generated in an area where the beam and the substrate faces each other, and causes the beam to be deformed in accordance with an electrostatic attraction generated by application of a DC voltage. The variable capacitance is generated in another portion where the beam and the substrate face each other, and the capacitance thereof changes in accordance with the displacement of the beam. The driving voltage control circuit detects a detection voltage that changes in accordance with the driving capacitance and controls the DC voltage applied to the driving capacitance such that the detection voltage approaches a desired value.

### BACKGROUND OF THE INVENTION

1. Field of the Invention

The present invention relates to variable capacitance devices that realize a variable capacitance using a MEMS component driven by an electrostatic force.

2. Description of the Related Art

To date, varactor diodes have been used as variable capacitance devices. A varactor diode is a type of semiconductor diode. When a reverse voltage is applied to a varactor diode, a depletion layer with no carriers is formed and the varactor diode operates as a capacitor having a capacitance corresponding to the depth of the depletion layer. When a reverse voltage applied to a Varactor diode is changed, the depth of the depletion layer is changed, whereby the capacitance is changed. Hence, a varactor diode operates as a variable capacitance device. However, the Q factor of a varactor diode operating as a capacitor is small and there is a large loss. Hence, in many cases, a varactor diode cannot be used in a circuit, such as a circuit for wireless communication, which requires a low-loss capacitor. Accordingly, a variable capacitance device in which a MEMS component is driven by an electrostatic force is often used as a low-loss variable capacitor in a wireless communication system (See, for example, Japanese Unexamined Patent Application Publication No. 2006-210843 and Japanese Unexamined Patent Application Publication No. 2008-182134).

FIG. 1 is a diagram illustrating an exemplary configuration of an existing variable capacitance device that utilizes a MEMS component.

A variable capacitance device 101 includes a movable plate 102 and a substrate 103. By using a micromachining technology, the movable plate 102 is formed as a MEMS component that can physically move up and down, and is connected to the substrate 103 through a spring structure (not illustrated). Two pairs of opposing electrodes are formed on the substrate 103 and the movable plate 102, and respectively form capacitance portions 105 and 106. By applying a driving voltage, the capacitance portion 105 generates a driving capacitance, and an electrostatic attraction corresponding to the driving voltage attracts the movable plate 102 to the substrate 103. The movable plate 102 stops at a position at which the electrostatic attraction is balanced with the spring force of the spring structure. The capacitance portion 106, which is inserted into a signal line to which a high-frequency signal is supplied, functions as a variable capacitor with a capacitance that corresponds to the position at which the movable plate 102 stops. The variable capacitance device 101 that is configured as described above can be used as a low-loss variable capacitor by optimizing the entire design of the device using a dielectric material with a small dielectric loss tangent and a low-resistance conductive material.

A type of variable capacitance device is a two-capacitance switching type device. The two-capacitance switching type device has two stop positions at which a movable plate stops. At one stop position, the variable capacitor provides a large capacitance, and at the other stop position, the variable capacitor provides a low capacitance. By connecting a plurality of such two-capacitance switching type devices in an array, the variable capacitor is configured so as to be adjustable in multiple steps within a predetermined range. As a result, the size and cost of the array are increased, which is a shortcoming of this variable capacitor.

A type of variable capacitance device that allows reductions in size and cost is a continuously variable capacitance type device. In a continuously variable capacitance type device, a movable plate is continuously displaced in accordance with a driving voltage such that the capacitance of the variable capacitor also changes continuously. There is a problem in that although a continuously variable capacitance type device has an advantage in terms of reduced size and cost, variations in the manufacturing of the spring structure directly cause variations in the capacitance characteristics of a variable capacitor with respect to a driving voltage, and it is very difficult to sufficiently reduce these variations with the precision of the current MEMS manufacturing technology. There is another problem in that an electrostatic attraction is generated by a signal voltage applied to the variable capacitor in addition to an electrostatic attraction generated by a driving capacitance, and the electrostatic attraction caused by the variable capacitor causes the movable plate to move closer to the substrate, whereby a phenomenon (self actuation) occurs in which the variable capacitance is increased to more than the set value. In view of these problems, it is considered in the study of currently available variable capacitance devices that a two-capacitance switching type device is appropriate for practical use.

### SUMMARY OF THE INVENTION

Accordingly, preferred embodiments of the present invention provide a variable capacitance device that can realize a high-accuracy variable capacitance and that is a continuously variable type device that has a low loss and an advantage in terms of reductions in size and cost.

A variable capacitance device according to a preferred embodiment of the present invention includes a substrate, a movable structure, a driving capacitance portion, a variable capacitor portion, and a driving voltage control circuit. The movable structure is connected to the substrate through a spring structure. The driving capacitance portion causes an electrostatic attraction based on a driving capacitance generated by application of a DC voltage to act between the movable structure and the substrate. In the variable capacitor portion, a capacitance generated by application of an RF signal changes in accordance with a positional relationship between the movable structure and the substrate. The driving voltage control circuit detects a detection voltage that changes in accordance with the driving capacitance and controls the DC voltage applied to the driving capacitance portion such that the detection voltage approaches a desired value.

With this configuration, the driving voltage control circuit determines the driving capacitance of the driving capacitance portion on the basis of a detection voltage, and controls a DC voltage applied to the driving capacitance portion so as to make the detection voltage approach a desired value. As a result, the accuracy with which the positional relationship between the movable structure and the substrate and the driving capacitance are set is increased and, hence, the accuracy of the capacitance of the variable capacitor portion is increased. In other words, even if there is a variation in spring force among products or a variation in the positional relationship between the movable structure and the substrate due to self actuation, the driving voltage control circuit automatically controls the DC voltage applied to the driving capacitance portion so as to compensate for these variations such that the accuracy of the capacitance of the variable capacitor portion is increased.

Preferably, the driving voltage control circuit of the present invention includes a DC source and an AC source, and the detection voltage is generated on the basis of a conversion voltage converted from an AC current flowing through the driving capacitance portion. The DC source applies a DC voltage to the driving capacitance portion, and the AC source superimposes an AC voltage to detect a capacitance on the DC voltage.

With this configuration, since a DC voltage output by the DC source is controlled, it is difficult to determine the driving capacitance from the DC voltage. Hence, by outputting a constant AC voltage to detect a capacitance from the AC source, it becomes possible to determine the driving capacitance from the detection voltage that is based on an AC current flowing through the driving capacitance portion.

Preferably, the driving voltage control circuit according to a preferred embodiment of the present invention further includes a reference capacitance having a known value, and the detection voltage is generated on the basis of a conversion voltage converted from an AC current flowing through the reference capacitance and a conversion current converted from an AC current flowing through the driving capacitance portion. Note that by connecting a series circuit including the reference capacitance and a resistor and a series circuit including the driving capacitance portion and a resistor in parallel, the driving voltage control circuit may generate the detection voltage on the basis of a difference between voltages at connection nodes in the respective series circuits. Alternatively, in the driving voltage control circuit, by connecting the reference capacitance and the driving capacitance in series at a connection node therebetween, the driving voltage control circuit may generate the detection voltage on the basis of a voltage at the connection node.

In the case of parallel connection, although the circuit configuration becomes complex since a differential circuit needs to be formed, it is easy to extract only a voltage corresponding to the difference between the driving capacitance and the reference capacitance because components of the same phase in the respective voltages cancel out each other. Accordingly, the accuracy of the capacitance of the variable capacitance portion is increased. On the other hand, in the case of series connection, the circuit configuration can be simplified.

Preferably, the driving voltage control circuit according to a preferred embodiment of the present invention samples the detection voltage at a timing at which a voltage drop in the detection voltage due to the driving capacitance portion becomes maximum.

For example, when a resistor connected in series with the driving capacitance is sufficiently small and the impedance of a circuit that is connected in parallel with the driving capacitance to detect a voltage is sufficiently high, a voltage drop in the detection voltage due to the capacitance component has a phase shift of 90° compared with the AC voltage to detect a capacitance. On the other hand, a voltage drop in the detection voltage due to the resistance component has no phase shift. Hence, when the detection voltage is detected at a timing at which the phase of the detection voltage with respect to the AC voltage for capacitance detection is 0° or 180°, the voltage drop due to the resistance component is cancelled out and the detection voltage can be sampled at a timing at which the voltage drop due to the capacitance component becomes maximum. As a result, the accuracy of the capacitance of the variable capacitor portion is increased. Note that, preferably, the sampled value of the detection voltage is compared with an external input voltage and then a DC voltage output by the DC source is increased or decreased.

The movable structure according to a preferred embodiment of the present invention may be a conductor or an insulator. When the movable structure is a conductor, electrodes (conductor layers) need not be newly formed and, hence, manufacturing is easy. When the movable structure is an insulator, manufacturing becomes complex since electrodes need to be newly formed. However, the design of a peripheral electric circuit connected to the variable capacitor becomes easy since the variable capacitor portion and the driving capacitance portion can be electrically separated. Note that in the case of a conductor, preferably, the conductor is single-crystal low-resistance silicon doped with high-density impurities and the volume resistivity is about 0.01 Ω-cm or less, for example, since loss can be reduced. In the case of an insulator, preferably, the insulator is single-crystal silicon and the volume resistivity is about 10 kΩ-cm or higher, for example, since electrical separation between the variable capacitor portion and the driving capacitance portion is enhanced. Since single-crystal silicon allows the use of high-accuracy micromachining, such as RIE or anisotropic etching using an alkali solution, manufacturing while significantly reducing and preventing variations is possible. Further, the substrate is preferably made of glass, since a movable structure made of silicon can be connected using highly reliable anode connection.

Preferably, the driving capacitance portion has a configuration in which a DC voltage is applied to an electrode pair, and the variable capacitance portion has a configuration in which a plurality of electrode pairs are connected in series and an AC voltage is applied to two open ends thereof.

According to a preferred embodiment of the present invention, the driving voltage control circuit determines the driving capacitance of the driving capacitance portion on the basis of a detection voltage, and controls a DC voltage applied to the driving capacitance portion so as to make the detection voltage approach a desired value. As a result, the accuracy with which the positional relationship between the movable structure and the substrate and the driving capacitance are set is increased and, hence, the accuracy of the capacitance of the variable capacitor portion is increased. In other words, even if there is a variation in spring force among products or a variation in the positional relationship between the movable structure and the substrate due to self actuation, the driving voltage control circuit automatically controls the DC voltage applied to the driving capacitance portion so as to compensate for these variations. As a result, the accuracy of the capacitance of the variable capacitor portion is increased.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating an exemplary configuration of an existing variable capacitance device.

FIGS. 2A and 2B are diagrams illustrating an exemplary configuration of a variable capacitance device according to a first preferred embodiment of the present invention.

FIG. 3 is a diagram illustrating a driving voltage control circuit of the variable capacitance device illustrated in FIG. 2.

FIG. 4 is a diagram illustrating a driving voltage control circuit of a variable capacitance device according to a second preferred embodiment of the present invention.

FIGS. 5A, 5B and 5C are diagrams illustrating an exemplary configuration of a variable capacitance device according to a third preferred embodiment of the present invention.

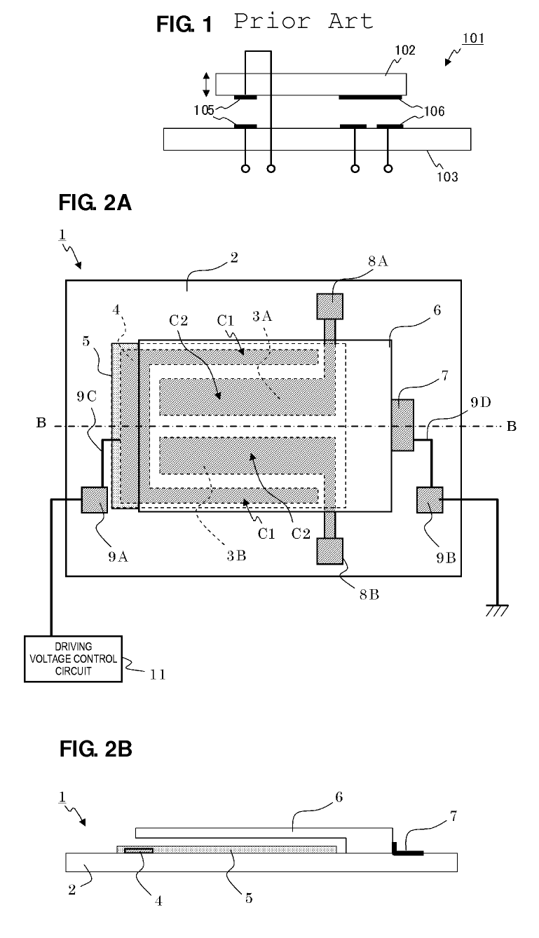

### DETAILED DESCRIPTION OF THE PREFERRED EMBODIMENTS

### First Preferred Embodiment

An exemplary configuration of a variable capacitance device according to a first preferred embodiment of the present invention will be described.

FIG. 2A is a plan view of a variable capacitance device 1. FIG. 2B is a cross-sectional side view of the variable capacitance device 1.

The variable capacitance device 1 includes a substrate 2, lower driving electrodes 3A, 3B, and 4, a dielectric layer 5, a beam 6, pad electrodes 7, 8A, 8B, 9A, and 9B, resistance patterns 9C and 9D, and a driving voltage control circuit 11. The substrate 2 preferably is a rectangular or substantially rectangular glass substrate, for example. The beam 6 is preferably shaped like a rectangular or substantially rectangular plate in plan view and is L-shaped in side view, for example. The beam 6 is a movable structure having a cantilever structure (spring structure) in which the right end in the figure is a support portion connected to the substrate 2 and supports the main portion such that the main portion is separated from the substrate 2. The beam 6 is preferably made of a low-resistance Si substrate (conductive material) with a resistivity of about 0.01 Ω-cm or less, for example, and P (phosphor), As (arsenic), B (boron), or other suitable material is used as a dopant.

The lower driving electrodes 3A and 3B, which are preferably L-shaped, are located on the top surface of the substrate 2 and include long line-shaped end portions along the axis direction (lateral direction in the figure) of the beam 6. The lower driving electrode 4, which is preferably U-shaped, is located on the top surface of the substrate 2 and is arranged so as to hold the two outer sides of the lower driving electrodes 3A and 3B between the two long line-shaped end portions that extend along the axis direction (lateral direction in the figure) of the beam 6. The dielectric layer 5 is preferably rectangular or substantially rectangular with a thickness of about 200 nm, for example, and preferably is formed of tantalum pentoxide, and is stacked on the substrate 2 so as to cover the end portions of the lower driving electrodes 3A and 3B and the two end portions of the lower driving electrode 4. The lower driving electrode 3A is connected to an input terminal (or output terminal) for an RF signal through the pad electrode 8A and the lower driving electrode 3B is connected to the output terminal (or input terminal) for the RF signal through the pad electrode 8B. The lower driving electrode 4 is connected to a DC voltage input end through the pad electrode 9A and the resistance pattern 9C. The beam 6 is connected to the ground through the pad electrodes 7 and 9B and the resistance pattern 9D. The resistance patterns 9C and 9D preferably are titanium oxide thin layers with a thickness of about 5 nm, and are designed to have a resistance of about 200 kΩ, for example.

The two end potions of the lower driving electrode 4 face the beam 6 with the dielectric layer 5 therebetween and define a driving capacitance portion (C1) according to a preferred embodiment of the present invention. The driving capacitance portion generates a driving capacitance C1 between the two end portions of the lower driving electrode 4 and the beam 6 when a DC voltage is applied from the driving voltage control circuit 11. The driving capacitance C1 causes the beam 6 to be deformed by an electrostatic attraction such that the beam is made to contact the dielectric layer 5 starting from the tip thereof. The higher the DC voltage, the larger the contact area.

The lower driving electrodes 3A and 3B face the beam 6 with the dielectric layer 5 therebetween and define a variable capacitor portion (C2) of the present invention. The variable capacitor portion is preferably used in a circuit that handles radio frequencies of several hundred megahertz to several gigahertz, and generates a variable capacitance C2 that changes in accordance with the contact area between the beam 6 and the dielectric layer 5. Here, the resistance patterns 9C and 9D preferably cut off a high-frequency leakage signal, because a high-frequency signal may leak from the variable capacitor portion to the driving voltage control circuit 11 and the ground through the beam 6.

Note that the driving capacitance portion (C1) has a structure in which a signal (voltage) is directly applied between the electrode pair (the lower driving electrode 4 and the beam 6). Hereinafter, this structure is referred to as an MIM structure. The variable capacitor portion (C2) has a structure in which two electrode pairs (the lower driving electrode 3A and the beam 6, the lower driving electrode 3B and the beam 6) are connected in series and a signal (voltage) is applied (hereinafter, this structure is referred to as an MIMIM structure). In the MIMIM structure, an electrostatic attraction per unit area is as small as about a quarter of that in the MIM structure and, hence, has an advantage in terms of significantly reducing and preventing deformation of the beam 6 caused by self actuation. On the other hand, in the MIM structure, an electrostatic attraction per unit area is larger than that in the MIMIM structure and, hence, has an advantage in terms of a reduction in the size of electrode areas. Accordingly it is preferable to use the MIM structure for the driving capacitance portion (C1) that requires a large electrostatic attraction and use the MIMIM structure for the variable capacitor portion (C2) that needs to significantly reduce and prevent an electrostatic attraction. Note that the driving capacitance portion (C1) and the variable capacitor portion (C2) may use either the MIM structure or the MIMIM structure.

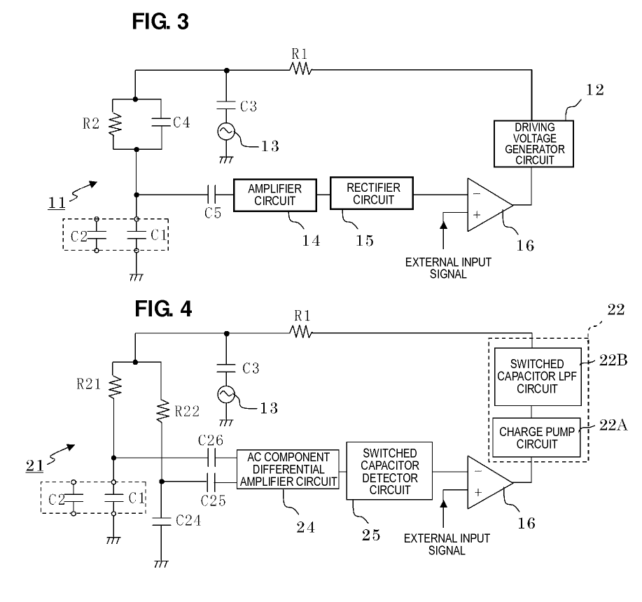

FIG. 3 is a diagram illustrating the circuit configuration of the driving voltage control circuit 11. The driving voltage control circuit 11 includes a driving voltage generator circuit 12, a capacitance detection AC signal source 13, an amplifier circuit 14, a rectifier circuit 15, and a comparator 16. The driving voltage generator circuit 12 is a DC source according to a preferred embodiment of the present invention and outputs a DC voltage to an AC cut-off resistor R1 (about 100 kΩ). The capacitance detection AC signal source 13 is an AC source of the present invention and outputs an AC signal of about 10 MHz, for example to detect capacitance to a DC cut-off capacitor C3 (about 100 pF, for example). The output end of the capacitor C3 is connected to the output end of the resistor R1, and a capacitance detection AC signal is superimposed on a DC voltage. The superimposed signal is input to a parallel circuit including a DC bypass resistor R2 and a reference capacitance C4. The output end of this parallel circuit is connected to the driving capacitance C1 of the variable capacitance device 1 to provide a capacitance circuit including the resistor R2, the reference capacitance C4, and the driving capacitance Cl.

The DC component of the superimposed signal is applied to the driving capacitance Cl through the DC bypass resistor R2 and causes the beam 6 in the variable capacitance device 1 to be deformed by an electrostatic attraction. The voltage of the AC component of the superimposed signal is divided by the reference capacitance C4 and the driving capacitance C1, and an amplitude corresponding to the ratio of the two capacitances is output to a DC cut-off capacitor C5 from a connection node between the reference capacitance C4 and the driving capacitance C1.

The output end of the DC cut-off capacitor C5 is connected to the amplifier circuit 14, and the amplifier circuit amplifies the voltage of an AC output from the voltage division node in the capacitance circuit to obtain a detection voltage according to a preferred embodiment of the present invention. Although not illustrated in the figure, a voltage follower having a very high input impedance is provided in the input portion of the amplifier circuit 14, which causes the AC output of the capacitance circuit to have a voltage that corresponds to simple voltage division performed by the reference capacitance C4 and the driving capacitance C1. The detection voltage amplified by the amplifier circuit 14 is rectified by the rectifier circuit 15. When the gain of the amplifier circuit 14, the reference capacitance C4, and the voltage of the capacitance detection AC signal source 13 are known in advance, the DC voltage output by the rectifier circuit is at a unique voltage in which the driving capacitance C1 has been reflected, and the larger the driving capacitance C1, the lower the voltage.

The comparator 16, which receives an external input voltage to specify the setting value of the driving capacitance and also receives the output from the rectifier circuit 15, outputs an output voltage that is switched between a LOW level and a HIGH level by comparing the two received voltages. When the detection voltage is higher than the external input voltage, in other words, when the driving capacitance C1 is smaller than the set value, the output level of the comparator 16 becomes HIGH, and, conversely, when the driving capacitance C1 is larger than the set value, the output level of the comparator 16 becomes LOW. The driving voltage generator circuit 12 increases or decreases a DC voltage output therefrom in accordance with the output voltage of the comparator 16. When the output voltage of the comparator 16 is at the HIGH level, the driving capacitance C1 is controlled so as to be increased by increasing the DC voltage, and when the output voltage of the comparator 16 is at the LOW level, the driving capacitance C1 is controlled so as to be decreased by decreasing the DC voltage. Through the above-described operation, the driving capacitance C1 is controlled by the driving voltage control circuit 11 to have the set value specified by the external input voltage. As a result of the driving capacitance C1 becoming equal to the set value, deformation of the beam 6 in the variable capacitance device 1 is controlled to be in a desired state, whereby the variable capacitance C2 is controlled to have a desired value.

### Second Preferred Embodiment

An exemplary configuration of a variable capacitance device according to a second preferred embodiment of the present invention will now be described. The variable capacitance device of the present preferred embodiment preferably has a structure similar to that of the first preferred embodiment, and is different from the first preferred embodiment only in terms of a circuit configuration of a driving voltage control circuit.

FIG. 4 is a diagram illustrating a circuit configuration of a driving voltage control circuit 21 of the variable capacitance device according to the present preferred embodiment. Note that circuit components that are the same as those of the first preferred embodiment are denoted by the same reference symbols.

The driving voltage control circuit 21 includes a driving voltage generator circuit 22, the capacitance detection AC signal source 13, an AC component differential amplifier circuit 24, a switched capacitor detector circuit 25, and the comparator 16. The driving voltage generator circuit 22 includes a switched capacitor LPF circuit 22B, and a charge pump circuit 22A, and outputs a DC voltage to the AC cut-off resistor R1. The capacitance detection AC signal source 13 outputs a capacitance detection AC signal to the DC cut-off capacitor C3. The output end of the capacitor C3 is connected to the output end of the resistor R1, and a capacitor detection AC signal is superimposed on a DC voltage. The superimposed signal is output to a bridge circuit (capacitance circuit) including resistors R21 and R22, a reference capacitor C24 (about 10 pF), and the driving capacitance C1. The parallel resistors R21 and R22 are connected to the superimposed signal input end in the bridge circuit. The resistor R21 is connected to the driving capacitance C1 and the resistor R22 is connected to the reference capacitor C24. The resistor R21 and the resistor R22 have the same resistance value.

The voltage applied to the path including the resistor R21 and the driving capacitance C1 by the superimposed signal is divided by the resistor R21 and the driving capacitance C1, and a voltage at the connection node is output to the AC component differential amplifier circuit 24 through a DC cut-off capacitance C26. The voltage applied to the path including the resistor R22 and the reference capacitor C24 by the superimposed signal is divided by the resistor R22 and the reference capacitor C24, and a voltage at the connection node is output to the AC component differential amplifier circuit 24 through a DC cut-off capacitance C25. The amplitudes of these two voltages correspond to the ratio of the driving capacitance C1 and the reference capacitor C24.

The AC component differential amplifier circuit 24 amplifies and outputs a difference signal between the two voltages. Accordingly, the signal amplified by the AC component differential amplifier circuit 24 becomes a detection voltage having an amplitude that corresponds to the driving capacitance C1. The detection voltage amplified by the AC component differential amplifier circuit 24 is subjected to phase detection performed by the switched capacitor detector circuit 25. Here, assuming that the resistor R21 connected in series with the driving capacitance C1 has a sufficiently small resistance and that the input impedance of the AC component differential amplifier circuit 24 is sufficiently high, the switched capacitor detector circuit 25 samples the detection voltage amplified by the AC component differential amplifier circuit 24 using timing pulses in synchronization with the phase 0° or 180° of the capacitance detection AC signal source 13. The switched capacitor detector circuit 25 accumulates electric charge in an internal capacitor on the basis of the sampled voltages and outputs an AC output corresponding to the electric charge. Regarding the detection voltage amplified by the AC component differential amplifier circuit 24, since voltage drops due to the resistance component and capacitance component of the bridge circuit vary with a phase difference of 90°, phase detection using the above-described timing pulses allows an influence from the resistance component to be cancelled out and, hence, allows an AC output that responds to the driving capacitance with high accuracy to be obtained.

The comparator 16, which receives an external input voltage to specify the setting value of the driving capacitance and also receives the output from the switched capacitor detector circuit 25, outputs an output voltage that is switched between the LOW level and the HIGH level by comparing the two received voltages. When the AC output of the switched capacitor detector circuit 25 is higher than the external input voltage, in other words, when the driving capacitance is smaller than the set value, the output level of the comparator 16 becomes HIGH, and, conversely, when the driving capacitance is larger than the set value, the output level of the comparator 16 becomes LOW.

The charge pump circuit 22A of the driving voltage generator circuit 22 increases or decreases the electric charge stored in the internal capacitor in accordance with the output level of the comparator 16 and increases or decreases the output voltage. The switched capacitor LPF circuit 22B of the driving voltage generator circuit 22 outputs a DC voltage obtained by removing frequency components to some extent from the output voltage of the charge pump circuit 22A. Hence, when the output voltage level of the comparator 16 is the HIGH level, the DC voltage increases such that the driving capacitance C1 is controlled so as to be increased, and when the output voltage level of the comparator 16 is the LOW level, the DC voltage decreases such that the driving capacitance C1 is controlled so as to be decreased. Through the above-described operation, the driving capacitance C1 is controlled by the driving voltage control circuit 21 to have the set value specified by the external input voltage. As a result of the driving capacitance C1 becoming equal to the set value, deformation of the beam 6 in the variable capacitance device is controlled to be in a desired state such that the variable capacitance C2 is controlled to have a desired value.

### Third Preferred Embodiment

An exemplary configuration of a variable capacitance device according to a third preferred embodiment will now be described. Note that the variable capacitance device of the present preferred embodiment preferably has a circuit configuration of a driving voltage control circuit similar to that of the first preferred embodiment, and is different from the first preferred embodiment only in terms of the configurations of a driving capacitance portion and a variable capacitor portion. The configurations similar to those of the above-described configurations are denoted by the same reference symbols, and the descriptions thereof are omitted.

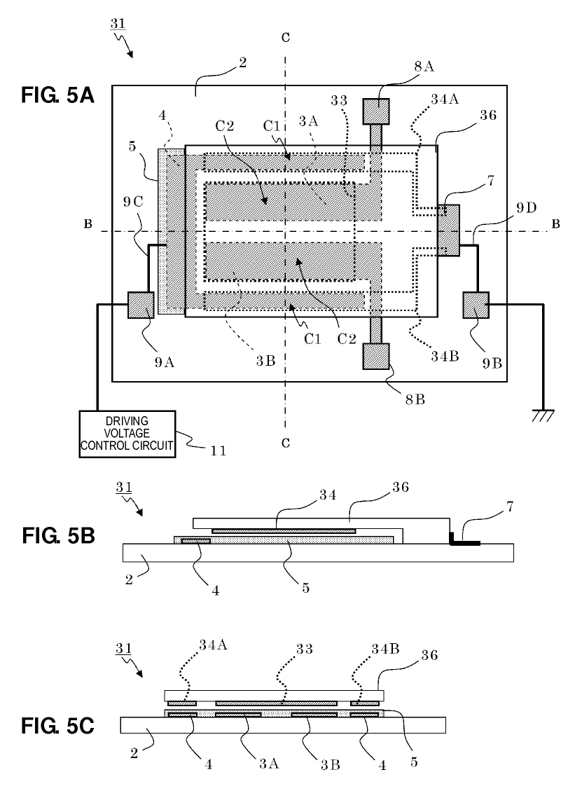

FIG. 5A is a plan view of a variable capacitance device 31. FIG. 5B is a cross-sectional side view of the variable capacitance device 31. FIG. 5C is a cross-sectional front view of the variable capacitance device 31.

The variable capacitance device 31 includes the substrate 2, the lower driving electrodes 3A, 3B, and 4, upper driving electrodes 33, 34A, and 34B, the dielectric layer 5, a beam 36, the pad electrodes 7, 8A, 8B, 9A, and 9B, the resistance patterns 9C and 9D, and the driving voltage control circuit 11. The beam 36 preferably is a high-resistance Si substrate (insulating material) having a resistivity of about 10 kΩ-cm or higher, for example.

The upper driving electrodes 34A and 34B are arranged so as to face the two end portions of the lower driving electrode 4 and are connected to the ground through the pad electrodes 7 and 9B and the resistance pattern 9D. The upper driving electrode 33 is arranged to be spaced apart from the upper driving electrodes 34A and 34B.

The two end portions of the lower driving electrode 4 face the upper driving electrodes 34A and 34B with the dielectric layer 5 therebetween and generate the driving capacitance portion (C1) according to a preferred embodiment of the present invention. The lower driving electrodes 3A and 3B face the upper driving electrode 33 with the dielectric layer 5 therebetween and generate the variable capacitor portion (C2) according to a preferred embodiment of the present invention. By arranging the upper driving electrode 33 so as to be electrically separated from the upper driving electrodes 34A and 34B, there is no possibility that a high-frequency signal will leak to the driving voltage control circuit 11 or the ground through the beam 6 as is the case with the first preferred embodiment and, hence, this configuration does not require that the resistance patterns 9C and 9D to cut off a high-frequency leakage signal be necessarily provided.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A variable capacitance device comprising:
a substrate;
a movable structure connected to the substrate through a spring structure;
a driving capacitance portion that causes an electrostatic attraction based on a driving capacitance generated by application of a DC voltage to act between the movable structure and the substrate;
a variable capacitor portion in which a capacitance generated by application of an RF signal changes in accordance with a positional relationship between the movable structure and the substrate; and
a driving voltage control circuit that detects a detection voltage that changes in accordance with the driving capacitance and that controls the DC voltage applied to the driving capacitance portion such that the detection voltage approaches a desired value.

2. The variable capacitance device according to claim 1, wherein the driving voltage control circuit includes:
a DC source that applies a DC voltage to the driving capacitance portion; and
an AC source that superimposes an AC voltage to detect a capacitance on the DC voltage; wherein
the detection voltage is generated based on a conversion voltage converted from an AC current flowing through the driving capacitance portion.

3. The variable capacitance device according to claim 2, wherein the driving voltage control circuit includes a reference capacitance having a known value, and the detection voltage is generated based on a conversion voltage converted from an AC current flowing through the reference capacitance and a conversion current converted from an AC current flowing through the driving capacitance portion.

4. The variable capacitance device according to claim 3, wherein a series circuit including the reference capacitance and a resistor and a series circuit including the driving capacitance portion and a resistor are connected in parallel in the driving voltage control circuit, and the driving voltage control circuit generates the detection voltage based on a difference between voltages at connection nodes in the respective series circuits.

5. The variable capacitance device according to claim 3, wherein, in the driving voltage control circuit, the reference capacitance and the driving capacitance are connected in series at a connection node therebetween, and the driving voltage control circuit generates the detection voltage based on a voltage at the connection node.

6. The variable capacitance device according to claim 1, wherein the driving voltage control circuit samples the detection voltage at a timing at which a voltage drop in the detection voltage due to the driving capacitance portion becomes maximum.

7. The variable capacitance device according to claim 6, wherein the driving voltage control circuit compares the sampled value of the detection voltage with an external input voltage and then increases or decreases a DC voltage output by the DC source.

8. The variable capacitance device according to claim 1, wherein the movable structure is made of a conductive material, and a resistor to cut off a signal is connected to the driving capacitance portion.

9. The variable capacitance device according to claim 1, wherein the movable structure is made of an insulating material, and electrodes that define the driving capacitance portion or the variable capacitance portion are located on a surface of the movable structure.

10. The variable capacitance device according to claim 1, wherein the driving capacitance portion has a configuration in which a DC voltage is applied to an electrode pair, and the variable capacitance portion has a configuration in which a plurality of electrode pairs are connected in series and an AC voltage is applied to two open ends thereof.
